(19) United States
(12) Patent Application Publication
(10) Pub. No.: US 2010/0087161 A1
(43) Pub. Date: Apr. 8, 2010

(54) PERSONAL SECURITY FEATURE FOR A REGULAR CAMERA PHONE

(75) Inventors: David Charles YOUNG, Cary, NC (US); Michael William RIPP, Raleigh, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB, Lund (SE)

(21) Appl. No.: 12/247,772

(22) Filed: Oct. 8, 2008

(51) Int. Cl. H04M 11/04; H04N 7/18; H04M 1/00

(52) U.S. Cl. 455/404.1; 348/143; 455/556.1; 348/E07.085

(57) ABSTRACT

A mobile communications device includes a camera and an LED flash. The camera is configured to photograph a series of images in rapid shoot mode. The user photographs the series of images of an assailant in response to recognizing imminent danger of an attack. A predetermined event, such as a user pressing a camera button or hot key on the mobile communications device three times in rapid succession or pressing a combination of buttons, begins the series of photographs. The photographs are automatically transmitted wirelessly to a central repository for later use. The predetermined event also initiates a call to an emergency call center and/or an audible alarm.

### BACKGROUND

Mobile communication devices, such as cellular phones and the like, have become increasingly prevalent. These devices provide the convenience of a handheld communication device that is capable of increased functionality. An expanding variety of features have become available, for example, short or multimedia messaging, multimedia playback, electronic mail, audio-video capturing, interactive gaming, data manipulation, web browsing, and the like. Mobile terminals have been equipped with versatile location-awareness technologies, such as global position system (GPS) tracking features. Such features enable a consumer to monitor the terminal position as well as transmit its location to emergency response personnel during emergency situations.

Many people carry mobile communication devices for security. However, in the case of an attack, the phone does not deter the attack. Rather, the phone assists after the event by calling for help. Further, sometimes having a mobile phone is the reason for an attack.

Accordingly, a need exists for a mobile communication device that can deter an attack and alert nearby people or emergency personnel for assistance. A further need exists for a mobile communication device that can record the identity of an attacker.

### DISCLOSURE

The above described needs are fulfilled, at least in part, by using the camera on a mobile communications device to photograph a series of images of an assailant in response to recognizing imminent danger of an attack. A predetermined event, such as a user pressing a camera button or hot key on the mobile communications device in rapid succession or pressing a combination of buttons, begins the series of photographs. The predetermined event can activate a rapid shoot feature of the camera to take a series of photographs and cause the communication device to automatically transmit photograph data to a central repository. Such data can serve as later identification of an assailant.

The predetermined event also may trigger initiation of a voice call to an emergency call center and cause the mobile device to issue a loud alarm signal concurrently with the taking of the photographs. During a call to an emergency call center, the mobile communication device may be in loud speaker mode. The alarm signal, as well as the loudspeaker output, can be an effective deterrent to a would-be assailant. The emergency call center may access the photograph from the central repository during the call. In addition, the location of the mobile device, as determined by a global positioning device contained therein, can be transmitted to the emergency call center.

The mobile communication device may include an LED that can be configured to flash with each camera exposure, thus effecting a further deterrent. The predetermined event, initiated by the user in response to sensing a threat from an assailant, thus causes the mobile device to implement a security operation mode.

Still other aspects, features, and advantages will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawings, and in which like reference numerals refer to similar elements and in which:

FIG. 1 is an illustrative view of structure of a mobile communication device;

FIG. 2 is block diagram of a mobile communication device; and

FIG. 3 is a flowchart of a method according to an exemplary embodiment.

### DETAILED DESCRIPTION

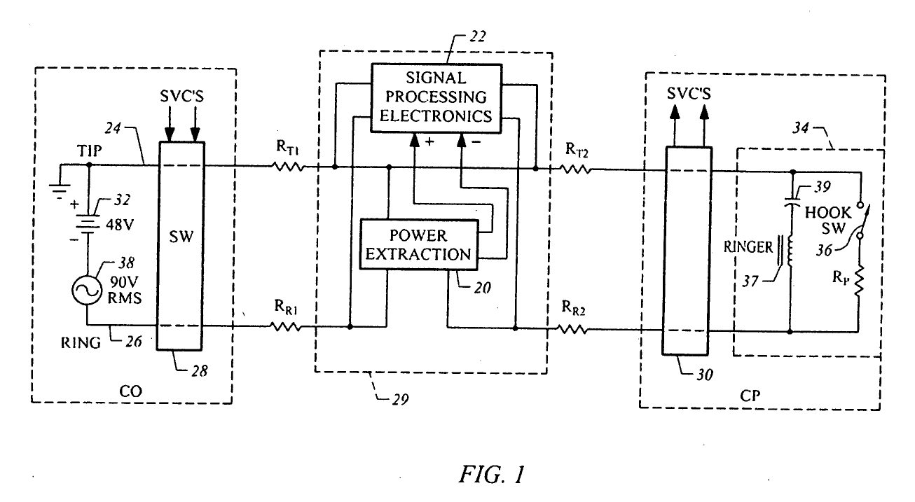

As shown in FIG. 1, mobile communication device 100 may embody any suitable handheld wireless communication device that includes a camera and a flash, such as a cellular, satellite, or other wireless phone with a multi-line display; a personal digital assistant (PDA) that may include wireless telephony features, a pager, “online” access, web browsing, an organizer, a calendar, and/or a radio (AM/FM) receiver; or a mobile computing device capable of wireless communications, such as a palmtop receiver or other handheld appliance that includes wireless telephony features. Mobile communication device 100 may also be referred to as a “pervasive computing” device capable of communicating with other devices via short messaging service (SMS) protocols or other protocols that allow for simultaneous communications of voice, data, and/or video information.

As shown in FIG. 1, mobile communication device 100 is a mobile phone, which may be provided in any suitable housing (or casing) 101, such as a fold (or clamshell) housing, slide housing, or swivel housing. Mobile communication device 100 includes display 103, keypad 105, microphone 107, and speaker 109. On the back side of mobile communication device 100 is camera 111. Camera button 113 and/or optional hot key 115 may be part of keypad 105 or may be located elsewhere on mobile phone 100.

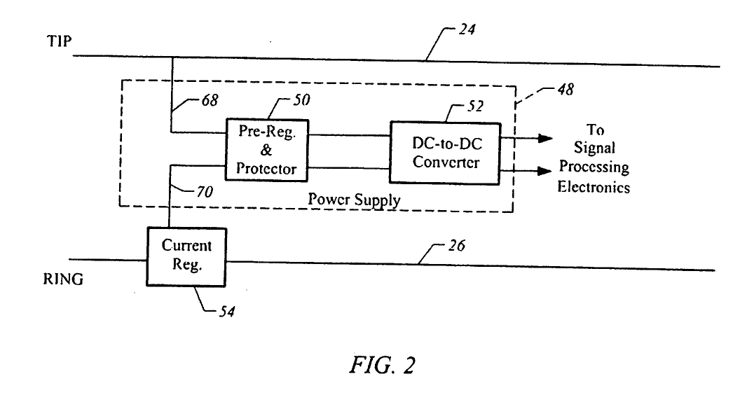

FIG. 2 is exemplary of mobile communication device 100. As shown, mobile communication device 100 may include communications circuitry 201, user interface 203, camera 205, LED 207, and alarm 209. While specific reference will be made thereto, it is contemplated that mobile communication device 100 may embody many forms and include multiple and/or alternative components.

User interface 203 includes display 211, keypad 213, microphone 215, and speaker 217. Display 211 provides a graphical interface that permits a user of mobile phone 100 to view call status, configurable features, contact information, dialed digits, directory addresses, menu options, operating states, time, and other service information, such as physical configuration policies associating triggering events to physical configurations for automatically modifying a physical configuration of mobile communication device 100, scheduling information (e.g., date and time parameters) for scheduling these associations, spatial positioning information, etc. The graphical interface may include icons and menus, as well as other text, soft controls, and symbols. In this manner, display 211 enables users to perceive and interact with the various features of mobile communication device 100. The menus may be used, for example, to program the camera button 113, hot key 115, or a combination of buttons to activate a security feature of mobile phone 100.

Microphone 215 converts spoken utterances of a user into electronic audio signals, while speaker 217 converts audio signals into audible sounds. Microphone 215 and speaker 217 may operate as parts of a voice (or speech) recognition system. Speaker 217 may operate in a loud speaker mode in which the volume level of the speaker is increased.

Keypad 213 may be a conventional input mechanism. That is, keypad 213 may provide for a variety of user input operations. For example, keypad 213 may include alphanumeric keys for permitting entry of alphanumeric information, such as contact information, directory addresses, phone lists, notes, etc. Various portions of keypad 213 may be utilized for different functions of mobile communication device 100, such as for conducting voice communications, SMS messaging, MMS messaging, etc. Keypad 213 may include a “send” key for initiating or answering received communication sessions, and an “end” key for ending or terminating communication sessions. Special function keys may also include menu navigation keys, for example, for navigating through one or more menus presented via display 211, to select different mobile communication device functions, profiles, settings, etc. Other keys associated with mobile communication device 100 may include a volume key, an audio mute key, an on/off power key, a web browser launch key, a camera key, etc.

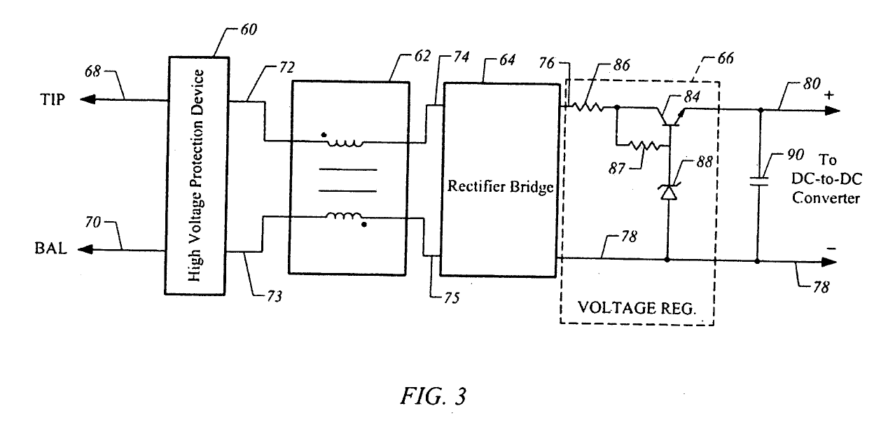

In accordance with the present disclosure, keypad 213 includes camera button 113 and optionally hot key 115, as shown in FIG. 1. The particular locations of camera button 113 and hot key 115 are not fixed and could be anywhere on the keypad or alternatively on the housing. If a user presses camera button 113, camera 111 can capture digital images and/or movies. Image and video files corresponding to the captured pictures and/or movies may be stored to memory 219. In accordance with the present embodiment, if a user presses camera button 113 or hot key 115 three times in rapid succession, the security feature will be activated, and a series of pictures will be captured and stored in memory 219, as will be described in detail with reference to FIG. 3. Three hits of either camera button 113 or hot key 115 avoids accidental activation. However, it should be noted that the number three is merely exemplary. The number of times for depressing camera button 113 or hot key 115 to activate the security feature may be set according to user preferences. Alternatively, a combination of keys, such as camera button 113 and hot key 115, may be programmed to activate the security feature.

Communications circuitry 201 enables mobile communication device 100 to initiate, receive, process, and terminate various forms of communications, such as voice communications (e.g., phone calls), SMS messages (e.g., text and picture messages), and MMS messages. In other instances, communications circuitry 201 enables mobile communication device 100 to transmit, receive, and process data, such as endtones, image files, video files, audio files, ringbacks, ringtones, streaming audio, streaming video, etc. As such, communications circuitry 201 includes audio processing circuitry 221, controller (or processor) 223, location module 225 coupled to antenna 227, memory 219, transceiver 229 coupled to antenna 231, and wireless controller 233 (e.g., a short range transceiver) coupled to antenna 235.

It is noted that a specific design and implementation of communications circuitry 201 can be dependent upon one or more communication networks for which mobile communication device 100 is intended to operate. Such networks may include any wireless local area network (LAN), metropolitan area network (MAN), wide-area network (WAN), or any other suitable communication network, or combination thereof. Communication networks may embody or interface with the public switched telephone network (PSTN), the Internet, or a proprietary network of a service provider, such as a network of an emergency response provider.

Location determination capabilities can be implemented on mobile communication device 100 via location module 225. In addition to manual entry of location information via, for example, user interface 203 (e.g., keypad 105), spatial position (or location) determinations may be performed when a positioning feature or service is made available to mobile communication device 100 through, for example, location module 225. Location module 225 may be any suitable position determining device, such as a satellite positioning system (SPS) receiver (e.g., a global positioning system (GPS) receiver, Galileo satellite system (GSS) receiver, etc.), hybrid assisted SPS device (e.g., GPS and advanced forward link trilateration (A-FLT) receiver, etc.), or radio network dependent receiver (e.g., enhanced cellular identification (CELL-ID) receiver, etc.), or other like device. In this manner, location module 225 may determine spatial positioning of mobile communication device 100 via one or more signals received by antenna 227 and processed by, for instance, location module 225 and/or controller 223.

Wireless controller 233 acts as a local wireless interface, such as an infrared transceiver and/or a radio frequency adaptor (e.g., Bluetooth adapter), for establishing communication with an accessory, hands-free adapter, another mobile communication device, computer, or other suitable device or network.

Processing communication sessions may include storing and retrieving data from memory 219, executing applications to allow user interaction with data, displaying video and/or image content associated with data, broadcasting audio sounds associated with data, and the like. Accordingly, memory 219 may represent a hierarchy of memory, which may include both random access memory (RAM) and read-only memory (ROM). Computer program instructions, such as “automatic physical configuration” application instructions, and corresponding data for operation, can be stored in non-volatile memory, such as erasable programmable read-only memory (EPROM), electrically erasable programmable read-only memory (EEPROM), and/or flash memory; however, may be stored in other types or forms of storage. Memory 219 may be implemented as one or more discrete devices, stacked devices, or integrated with controller 223. Memory 219 may store program information, such as one or more user profiles, one or more user defined policies, one or more triggering events, one or more physical configurations, scheduling information, etc. In addition, system software, specific device applications, program instructions, program information, or parts thereof, may be temporarily loaded to memory 219, such as to a volatile storage device, e.g., RAM. Communication signals received by mobile communication device 100 may also be stored to memory 219, such as to a volatile storage device.

Controller 223 controls operation of mobile communication device 100 according to programs and/or data stored to memory 219. Control functions may be implemented in a single controller (or processor) or via multiple controllers (or processors). Suitable controllers may include, for example, both general purpose and special purpose controllers, as well as digital signal processors, local oscillators, microprocessors, and the like. Controller 223 may also be implemented as a field programmable gate array (FPGA) controller, reduced instruction set computer (RISC) processor, etc. Controller 223 may interface with audio processing circuitry 221, which provides basic analog output signals to speaker 217 and receives analog audio inputs from microphone 215.

Controller 223, in addition to orchestrating various operating system functions, also enables execution of software applications, such as a location determination application for resolving spatial positioning of mobile communication device 100 based on one or more signals received at antenna 227 and processed by location module 225 and/or controller 223. Other software modules may be provided for sensing ambient conditions, or detecting triggering events (e.g., event detector module 237). In the security operation mode for mobile communication device 100, controller 223 may operate the LED 207 to flash in synchronism with each camera exposure. Controller 223 may also control alarm 209 to emit an alarm signal as part of the security operation mode.

FIG. 3 illustrates an exemplary embodiment of the security feature of mobile communication device 100. In accordance with FIG. 3, a user senses a threat of attack at step 301. The user at step 303 initiates the security feature of mobile communication device 100. The user presses the camera button 113 or the hot key 115 a predetermined number of times (preferably 3) in rapid succession or presses a preprogrammed combination of keys. The user immediately holds device 100 such that camera 111 is directed towards the assailant at step 305. At step 307, camera 111 begins taking a series of photographs in rapid shoot mode. In rapid shoot mode, the camera photographs several images at fixed intervals over a short period of time. The number of photographs may be set according to user profiles and according to the memory capability of the mobile communication device 100. The photographs are taken in synchronization with LED flashes, i.e., from LED 207. The flashes potentially distract the assailant while helping to attract attention from nearby persons. The photographs, at step 309, are transmitted wirelessly via a data transfer over a wireless network to a central repository and are automatically uploaded. The location of the repository is not limited and may be, for example, at an operator, an emergency call center (ECC), or a base station. The photographs may be used after the attack to identify the assailant. Accordingly, the ECC or local authorities may preferably access the repository.

Concurrently with the photographs being taken, at step 311 mobile communication device 100 automatically initiates a voice call to the ECC. Mobile phone 100 automatically switches into a loud speaker mode, such that the voice from the ECC can be heard by the assailant. The ECC preferably accesses the photographs at the central repository. At step 313 during the call, location information for the mobile communication device 100 is obtained via location module 225 and transmitted to the ECC.

Also concurrently with the photographs being taken, at step 315 an alarm signal may be emitted from alarm 209 of mobile communication device 100. The noise level of the alarm signal should be maximized so as to be heard by the assailant and to attract attention to alert persons nearby that help is needed. The alarm signal may be a recorded voice or a sound similar to a car alarm. Although FIG. 3 shows both a call to the ECC (step 311) and an alarm signal (step 315), practically speaking the voice from the ECC and an audible alarm signal cannot be emitted from device 100 simultaneously. Accordingly, the alarm signal may be substituted for a call to the ECC, or the alarm signal may be eliminated. Alternatively, if both the alarm signal and the call are to occur, the alarm signal may be interrupted when the call to the ECC is answered. The alarm signal may then resume if the call is terminated. Still further, the alarm signal may begin as an audible alarm, then switch to a visual alarm (such as a flashing light) during the call to the ECC, and then return to an audible alarm when the call is terminated.

Using the security feature as illustrated in FIG. 3, by pressing a button or a combination of buttons on a mobile communication device 100, a user can attract attention in an attempt to scare away an assailant and may even deter an attack. The user can also call for assistance from an ECC. Further, the user can record the identity of the assailant.

In this disclosure there are shown and described only preferred embodiments and but a few examples of its versatility. It is to be understood that the disclosure is capable of use in various other combinations and environments and is capable of changes or modifications within the scope of the inventive concept as expressed herein.

What is claimed is:

1. A method comprising:
recognizing imminent danger from an assailant;
in response to the recognition of danger, photographing an image of the assailant using a mobile communications device; and
automatically transmitting assailant image data to a remote destination.

2. A method as recited in claim 1, wherein the step of photographing comprises rapidly exposing a series of images of the assailant.

3. A method as recited in claim 2, wherein the remote destination comprises a central repository.

4. A method as recited in claim 2, wherein the step of photographing further comprises activating a key on the mobile communications device.

5. A method as recited in claim 4, wherein the step of activating comprises contacting the key in rapid succession.

6. A method as recited in claim 3, further comprising:
automatically initiating a voice call to an emergency call center.

7. A method as recited in claim 6, further comprising:
activating a loud speaker mode in the mobile communications device during the call.

8. A method as recited in claim 6, further comprising:
accessing the assailant image data from the central repository by the emergency call center.

9. A method as recited in claim 6, further comprising:
determining location information for the mobile communications device; and
transmitting the location information to the emergency call center during the call.

10. A method as recited in claim 6, further comprising:
emitting an audible alarm signal from the mobile communications device.

11. A method as recited in claim 1, further comprising:
emitting an audible alarm signal from the mobile communications device.

12. A mobile communications device comprising:
a controller;
a camera; and
an LED flash;
wherein the controller is configured to implement a security operation mode for activating a rapid series of camera exposures and corresponding LED flashes.

13. A mobile communications device as recited in claim 12, further comprising a user keypad coupled to the controller; wherein the controller is configured to be responsive to successive contacts of a user key to actuate the security operation mode.

14. A mobile communications device as recited in claim 12, further comprising a user keypad coupled to the controller; wherein the controller is configured to be responsive to contact of a hot key of the keypad to actuate the security operation mode.

15. A mobile communications device as recited in claim 12, further comprising an audible alarm; wherein the controller is configured to activate the audible alarm during the security operation mode.

16. A mobile communications device as recited in claim 13, further comprising a communications circuitry and a location module coupled to the controller; wherein the controller is configured to transmit location data determined by the location module to a remote destination during the security operation mode.

17. A mobile communications device as recited in claim 16, wherein the controller is configured to transmit camera exposure image data to a remote repository during the security operation mode.
